(19) United States
(12) Patent Application Publication
(10) Pub. No.: US 2007/0272797 A1
(43) Pub. Date: Nov. 29, 2007

(54) Engine exhaust for modifying a target

(76) Inventors: Boris Skurkovich, Pawtucket, RI (US); Melvin A. Millstein, La Jolla, CA (US); Simon Skurkovich, Rockville, MD (US)

Correspondence Address: HOUSTON ELISEEVA, 4 MILITIA DRIVE, SUITE 4, LEXINGTON, MA, 02421, US

(21) Appl. No.: 11/438,896

(22) Filed: May 23, 2006

(51) Int. Cl. B64B 1/62; B64C 35/00

(52) U.S. Cl. 244/98; 244/101; 244/99

(57) ABSTRACT

A method for modifying a target includes directing exhaust from multiple engines, preferably jet engines, towards the target. The target being modified can be, for example, a fire, an atmospheric system, a storm, snow, a gathering, a spill, an emission, a discharge, a mud slide, or a dust. The operation and/or deployment of the engines can be by remote control or robotics. In one example, a system for modifying a target includes a support for securing multiple jet engines and a fuel source. Preferably, the jet engines are mounted on turrets that are capable of being rotated.

### BACKGROUND OF THE INVENTION

Disasters such as floods, snow accumulations, mud slides, lava flow, chemical, e.g., oil, spills, storms, fog, structural collapses, fires and so forth can result in loss of human life, property damage and considerable commercial costs, often in billions and billions of dollars each year. In many cases, little can be done to stop or attenuate the intensity of such events. In the aftermath, clean-up operations often are slow and painstaking.

Fires, for example, can intensify rapidly and often can persist for hours, days or even weeks. To exist, most fires require fuel, oxygen, and a minimal ignition temperature at which the fuel will combust. The most common approach to suppress or extinguish a fire is to smother it with sufficient water to cut off the air supply and cool the fire below the ignition temperature of the fuel. Where enough water is available heat sensing water sprinkler systems are installed to quickly put out small fires in a room or building. Firefighting teams generally need to have access to water delivered under pressure through a hose to the fire.

Means other than water are employed, for example in the case of electrical fires, when water supply and/or its delivery are unavailable or because of potential damage to water sensitive materials, such as archived documents, sensitive electronic equipment, art works, or photographs. Examples include fire retardant or fire extinguishing chemicals such as nonflammable fluorocarbons in liquid or foam form; inert gases such as argon or nitrogen used to displace the oxygen-containing air supply at the fire; and pressurized carbon dioxide stored in tanks, cylinders, or in frozen state.

It also has been reported that coal seam fires have been starved of oxygen and eventually extinguished by pumping gas with very low oxygen concentrations obtained from a CSIRO GAG3A Inert Gas Generator, together with steam, into the area of the mine fire.

In some cases, however, a fire can reach a stage in which many of the aforementioned methods are inadequate or have only limited success. Forest fires, for instance, can spread freely and, along with fires sustained by flammable chemicals, often prove extremely dangerous to fire fighters.

### SUMMARY OF THE INVENTION

A need exists for methods that can be used to control a target such as a fire, flood, mud slide, oil spill, storm, fog or other atmospheric disturbance. A need also exists for systems that can be deployed to the site of the target. Methods and systems that can be used in clean-up efforts, for instance in snow removal or debris clearing are needed as well. Furthermore, a need exists for ways of dispersing gatherings of birds, humans or insects. In fire fighting, also needed is a mobile system that does not depend on water.

Generally, the invention relates to the use of exhaust from an engine, preferably a jet engine. In one aspect, the invention relates to a method in which the exhaust, preferably having high velocity, such as, for instance the exhaust ejected by a jet engine, is directed towards a target.

The engine can be alone or in a cartridge including multiple engines. In one example, multiple engines are mounted on a platform in a manner that allows swivel or rotation of each engine. An operator, robot or a remote operator, via remote control, can position the engine to direct engine exhaust towards the target. For deployment to the target site, the engines can be installed on fire or regular trucks, tanks, ships, helicopters, planes, rockets, e.g., low speed rockets, or other means of transportation. In one example, the engines are carried by cranes.

In one embodiment, the invention is directed to a method for displacing a target or a part thereof. The method includes deploying a jet engine to a target site and directing an exhaust generated by the jet engine towards the target, thereby displacing it or a part thereof.

In some cases, the engine or combination of engines is deployed and/or operated by remote control or robotically. In one example, the invention is directed to a method for modifying a target, the method including deploying multiple jet engines to a target site by remote control or robotically; and directing exhausts generated by the multiple jet engines to the target, thereby modifying it.

In another example, the invention is directed to a system for modifying a target. The system includes at least one jet engine; a first apparatus for deploying by remote control or robotically the at least one jet engine to a target site; and a second apparatus for directing an exhaust generated by the at least one jet engine to the target by remote control or robotically.

In a further embodiment, the invention is directed to a system for modifying a target, the system including multiple jet engines secured to a support; a central processing unit for operating the jet engines remotely or by robot; and a conduit for supplying fuel from a fuel source to the jet engines;

The invention has many advantages. It is useful, for example, in preventing or mitigating natural disasters, extinguishing fires, clearing land of snow, rocks or debris, altering atmospheric conditions, displacing flood water or mud slides, controlling oil spills and in many other situations such as, for example:
cleaning of large roofs from snow, dirt, trash, rocks, and gravel;
stopping or delaying an impending storm;
dispersing clouds, for instance in order to prevent hail,
stopping slides of mud, rocks, dirt, dust and other substances from hills, mountains, and other elevations;
dispersing gatherings or crowds;
stopping or delaying floods on rivers, lakes, seas, and oceans;
stopping leaks in levies, dykes, and dams;
speeding up transition of logs downstream;
stopping or slowing down lava flow;
dispersing flocks of wild birds and insects (e.g., locust);
fighting fires in forests, fields and in structures.

In the case of fire, fire fighting can be conducted without water damage. By controlling the deployment and/or operation of jet engines remotely or by robot, the invention can save lives of fire fighters or emergency personnel.

In one aspect, the invention relates to a self-contained system which includes multiple engines, preferably jet engines, a fuel source and conduits for feeding the fuel. New or used engines can be employed. The system is versatile with regard to the target it can modify and is self contained. It can modify simultaneously a large target area. In one example, the invention provides for a shielded system that can be brought close to a blaze or another hot target, e.g., lava, while minimizing fire damage.

In further aspects, the system is mobile and versatile with respect to its deployment to a target site. For instance, the system can be provided with cables and attachment for its deployment and/or retrieval by helicopter or parachute. In other embodiments, the system is designed for transportation by land or water.

For many applications, no conduits for directing the exhaust to the target need to be employed and the system described herein can be used to modify targets out in the open, unconfined by structural walls, separations or partitions.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as limitations of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a top view of a cartridge that can be deployed to a target site and which includes multiple turbine engines.

FIG. 2A is a side view of another cartridge which includes multiple turbine engines and an assembly for deploying and/or retrieving it to a target side.

FIG. 2B is another side view of the cartridge shown in FIG. 2A being deployed by a helicopter.

FIG. 3 is a schematic diagram of a cartridge protected by a shield and deployed from an aircraft.

FIG. 4A and FIG. 4B are, respectively, a side and a front view of a plane, preferably pilotless, transporting multiple jet engines.

FIG. 5A and FIG. 5B are, respectively, a side and a top view of a track vehicle transporting multiple turbine engines.

FIG. 6A is a side view of a tractor trailer carrying a rotatable turbine engine.

FIG. 6B is a side view of multiple turbine engines that can be transported by a tractor trailer such the one illustrated in FIG. 6A.

FIG. 7 is a schematic diagram of a remote command system for operating a jet engine.

### DETAILED DESCRIPTION OF THE PREFERRED EMBODIMENTS

The invention generally relates to the use of exhaust generated by one or more engines, preferably jet engines. More specifically, the invention relates to using the exhaust to modify a target, for instance by smothering, suppressing, dispersing, displacing, deflecting, melting or otherwise controlling it. As used herein, the terms “moving”, “dispersing”, “displacing” or “deflecting” a target or a part or portion of the target generally are referred to as “displacing” a target, or a part thereof.

The target can be a fire, e.g., an above-the-ground forest, dwelling, commercial or industrial fire. As with fires, explosions also can be suppressed or smothered.

Targets such as chemical spills, e.g., a petroleum spill at sea, discharges or emissions of dust, poisons, harmful vapors, e.g., ammonia, gas blankets, e.g., carbon monoxide, liquid pollutants or sludges also can be modified, often by a dispersing mechanism.

Dispersing also can be used on targets that include a biological agent such as a mass of viruses or bacteria, produced, for instance by a dusting. In other aspects the target dispersed or displaced is an atmospheric system, for example a fog or cloud cover. The invention also can be applied to targets such as hurricane or tornado formations. In other examples, the target moved is a mass of water, for instance a flood, an ocean wave or an accumulation of snow such as produced by heavy precipitation, avalanches or drifting. In yet other instances the target is an accumulation of mud, such as formed during a mud slide.

The invention also can be used to move a target such as timber down a river, to clear debris from collapsed structures or during exploration or construction work. The invention also can be practiced to clear land after earthquakes, tornadoes, or hurricanes. In other instances, roofs, balconies or terraces can be cleared of snow.

In further embodiments, the target dispersed is a gathering such as an undesirable, nuisance or harmful flock of birds, for example birds carrying avian flu, geese, pigeons, starlings, crows or other nuisance birds on golf courses, cities or crop fields. The target also can be a swarm of locust, ants, mosquitoes or other insects. In further embodiments, the invention is practiced to disperse riots or other potentially dangerous crowds.

The target or part thereof can be contained within a structure, e.g., a building, an underground tunnel, a vessel. Examples of targets confined by structural walls, separations or partitions include mine fires, underground explosions, pest infestations within buildings and so forth.

In many cases, the target is not confined. Examples include storm formations, floods, snow accumulations, forest fires and many others.

Suitable engines that can be employed to generate an exhaust include pulsejet engines, turbojet engines, turbojet engines with afterburner, axial-flow turbojets, gas turbine propulsion engines, rocket engines, turbofan aircraft engines, low-bypass turbofans, high-bypass turbofans, turboprops, ramjets, turboshaft engines, underwater jet engines, shockwave triple engine jet trucks and others. Combinations of different types of engines also can be used.

In preferred embodiments of the invention, the exhaust is obtained from one or more jet engines. As used herein, the term “jet engine” refers to an engine that accelerates and discharges a fast moving jet of fluid, e.g., a gas such as exhaust gas, to generate thrust.

In a turbojet engine, for example, air from an air intake is directed to a rotating compressor where its pressure and often its temperature are increased. Pressurized air is introduced to a combustion chamber where it is combined with fuel and the mixture is ignited. Fuels that can be employed preferably include hydrocarbon-based fuels such as methane, propane, natural gas, kerosene, jet fuels, and others. The combustion raises the temperature of the gases, which expand through a turbine. In the turbine some of the temperature rise is converted to rotational energy, which can be used to drive the compressor. The gas jet exits the engine through an exhaust nozzle.

Air inlets can be subsonic or supersonic. The combustion air can be enriched in oxygen or pure oxygen can be employed. The compressor generally is coupled to the turbine via a turbine shaft and can produce centrifugal flow or axial flow.

Examples of combustion chamber designs include can, annular, can-annular, and others. Multiple combustion chambers can be used. Flame ignition can be by techniques known in the art. Laser ignition or hydrogen ignition can be employed. In one example ignition is with hydrogen with low spark ignition energy of about 0.0182 millijoules (mJ).

Preferably the turbine is a gas turbine, which acts like a windmill, extracting energy from the hot gases leaving the combustor. Suitable types of turbines that can be utilized include transonic turbines, contra-rotating turbines, statorless turbines, ceramic turbines, shrouded as well as shroudedless turbines and others known in the art. Micro turbines are preferred for modifying some targets, for instance in small-scale applications, such as clearing roofs, dispersing birds from a golf course and so forth.

The exhaust nozzle can be a convergent-divergent, divergent, fluidic, variable, e.g., ejector nozzles, iris nozzles, or can have another suitable design.

Generally, jet engine exhaust is characterized by its temperature, chemical composition, velocity, delivery volume, rate of delivery, pressure and by other parameters, e.g., noise, air quality, and so forth.

Exhaust from a jet engine can have a temperature of several hundreds degrees centigrade (° C.), for instance about 500° C. or higher, e.g., 650° C. In many jet engine designs, piping and exhaust nozzles are protected by air cooling.

Exhaust gas temperature or EGT can be measured using a thermocouple in the exhaust. The raw thermocouple voltage is amplified and scaled to provide a real-time display of the temperature in Celsius, and is also logged. This temperature can be one of the control loop inputs, to prevent sudden throttle changes from exceeding the turbine limitation.

In some applications, exhaust can be used at the temperature provided by the cooling system with which the jet engine is equipped, for instance a conventional air cooling arrangement. Situations which may require no further temperature reductions include melting a snow accumulation, moving water or atmospheric disturbances, and others.

For dispersing riots, animals or birds, or for controlling fires or explosions, lower exhaust temperatures are preferred and water, dry ice, refrigerant or cryogenic cooling can be used to replace or supplement air cooling. Devices that can be used include heat exchangers, cooling coils, diesel oxidation catalysts and so forth. In the case of cryogenic cooling, a preferred cryogenic fluid is liquid nitrogen. In a preferred example, the temperature of an exhaust employed with live targets is about body temperature, e.g., not higher than about 38° C.

In one aspect of the invention, refrigerant conducting coils are placed around and/or in the pathway of the exhaust. In other aspects, the exhaust is cooled by passing it through cooling chambers, pipes, hoses or other conduits. The exhaust also can flow through a cooling chamber cooled by a refrigerant compressor that uses pressure generated through the movement of exhaust gases through a turbine fan.

A specific arrangement uses an exhaust cooling system disclosed in U.S. Pat. No. 6,301,877, to Liang et al., issued on Oct. 16, 2001, the teachings of which are incorporated herein by reference in their entirety. The cooling system includes an extension piece extending axially downstream of the nozzles variable throat that utilizes fan air to cool the forward portion of the divergent nozzle surfaces adjacent to the gas path of the engine and ram air to cool the surfaces downstream of the ejector. A variable vane varies the area of the ejector slot.

Another arrangement is disclosed in U.S. Pat. No. 6,301,887, to Gorel et al., issued on Oct. 16, 2001, the teachings of which are incorporated herein by reference in their entirety. The arrangement includes a low pressure exhaust gas re-circulation (EGR) that can be used as a passive retrofit system. The EGR loop inlet can be positioned upstream of the exhaust particulate filter and downstream of the turbine to utilize backpressure created by the exhaust particulate filter to insure EGR flow in the loop. A catalyzed soot filter in communication with the EGR pickup can be used to ensures cleansed EGR gases at the EGR return downstream of the air filter and upstream of the compressor. Cooling of the EGR gases is provided by a corrugated EGR line.

In yet another arrangement, the exhaust system has a bent exhaust pipe that allows evacuating the exhaust jet downwards and aside as described in Russian Patent document RU22 16487 to Martinov, published on Nov. 20, 2003, the teachings of which are incorporated herein by reference. More specifically, the exhaust pipe can have an inner pipe with exhaust nozzle and a shell secured on it in front portion. Nozzle and shell are interconnected by means of detachable casing, thus forming an external loop of exhaust pipe which forms in its turn clearance between the inner pipe for passage of part of cooling air under action of an ejector. Under action of an ejector formed by mixing exhaust nozzle fitted on engine and front end of inner pipe, part of air is sucked into the inner pipe lowering its temperature. The exhaust pipe can be secured on an external wall of the beam and can be strengthened by two rods. The inner pipe can be connected with the shell and exhaust nozzle by means of trapezoidal profiles.

In a further arrangement the exhaust is cooled as described in Japanese Patent document JP11064168 to Ishikawajima Harima Heavy Ind., and published on Mar. 5, 1999, the teachings of which are incorporated herein by reference in their entirety. Specifically, this equipment includes a vertical cooling tower, a horizontal inlet duct, water jacket and two weirs and permits changing the flow of hot exhaust from a horizontal to a vertical direction.

With respect to its chemical composition, jet engine exhaust gas generally includes products of combustion, e.g., carbon dioxide (CO₂), carbon monoxide (CO), and water (H₂O), un-combusted gas, e.g., nitrogen gas (N₂), oxygen (O₂), uncombusted hydrocarbons (UHC) and other components such as soot (C), oxides of nitrogen (NOₓ) and/or oxides of sulfur (SOₓ).

Compared to atmospheric air, which at sea level contains close to 21% by volume O₂ and about 0.03% by volume CO₂, jet engine exhaust has lower O₂ and higher CO₂ levels. For instance, the pressurized emission products of the complete combustion of hydrocarbon fuels in an efficiently operated turbine engine are comprised of about 72% volume/volume CO₂ gas and about 27.6% volume/volume of steam.

The chemical composition of the exhaust gas plays an important role when the invention is used to control or extinguish a fire. Studies in which carbon dioxide was introduced into an enclosed room have shown that CO₂ concentrations of at least 5.6% volume/volume and O₂ concentrations of no more than 15% volume/volume will not sustain a fire. Low O₂ concentrations also are preferred for applications such as controlling explosions or destroying insects and some types of bacteria.

Manipulating the ratio of air to fuel, for instance by using a throttle mechanism, diluting with inert gases or by other means, can lower the oxygen concentration in the exhaust.

If the jet engine employs air cooling, preventing or minimizing its mixing into the exhaust gas, can reduce the O₂ concentrations in the stream employed to modify a target. This can be accomplished by deflecting the direction of exiting cooling air. If an annular arrangement is employed, cooling air can be ejected outwardly in a direction essentially perpendicular to that of the exhaust. One or more orifices, piping or other types of outlets can be employed. In other embodiments, cooling air is replaced with water, refrigerant or cryogenic cooling.

In applications in which the exhaust can affect living beings, for instance people or pets trapped in a fire, or in crowd dispersing applications, oxygen can be combined with the exhaust to provide an overall oxygen content that can sustain breathing.

In some cases, combustion conditions and parameters also are optimized to decrease the emission levels of NOₓ and/or SOₓ.

Generally, the exhaust can have a velocity of at least 250 miles per hour (mph), preferably at least about 1000 mph. High velocities are preferred in applications that involve dispersing, displacing or redirecting targets such as debris, logs, water masses, floods, waves, clouds, lava, fog, mud slides, and so forth. In one example, the velocity of the exhaust is about 1300 miles per hour (mph).

Many of the applications disclosed herein preferably use a high volume exhaust delivery. Engine throttles, preferably remote or robotically controlled ones, can be used to reduce the pressure of the exhaust, for instance as target modification is winding down. Reduced speed or velocity of the exhaust also is preferred when the exhaust is directed to people or animals.

To modify the target, an engine, e.g., a jet engine preferably is positioned sufficiently close to the target for the exhaust to reach the target and effect its modification. The jet engine can be fixed in position or, preferably, is provided with a mechanism that allows positioning the exhaust nozzle in a manner such that exhaust is directed towards the target. A swivel arrangement that allows it to turn can be used. In one example, the engine is mounted on a pedestal, for instance a rotatable turret. Mechanisms for the vertical and/or horizontal movement of the jet engine also can be included.

In preferred aspects, the operation of the jet engine is by remote control or by robotic engineering. Computer controls, communications and software codes for automatic control from remote locations or by robot have been used in space exploration, compressors and turbines for pipeline transport, car racing, and other fields. Video displays can be employed as can voice recognition or radio commands. A remotely controllable throttle valve disposed within the exhaust duct of an engine for selectively diverting exhaust gases through a bypass duct for mixing with the ventilation airflow for the purpose of reducing the oxygen content in the airflow is disclosed, for instance in U.S. Pat. No. 5,848,652 issued on Dec. 15, 1998 to Bennett, the teachings of which are incorporated herein by reference in their entirety.

In further aspects, remote controls or robotics are used to control the velocity, e.g., direction, the temperature, chemical composition, delivery rate, delivery volume or another parameter of the exhaust. The direction of the exhaust can be controlled, for instance, by rotating a supporting turret. Parameters such as the temperature and/or chemical composition can be controlled by controlling combustion parameters, cooling rates or by other means. Delivery rates and/or delivery volume can be controlled by controlling combustion conditions, by partially or completely opening or shutting off exhaust conduits, or by other means. In some cases, jet engine exhaust piping is provided with vanes or louvers, which can be closed or opened to control the exhaust flow rate.

Preferably, exhaust from multiple jet engines is employed. As used herein, the term “multiple” or a “plurality” refers to at least two. When more than one jet engine is used, they can be arranged in a manner which increases or maximizes the action of their exhausts upon the target. Straight lines, circle, semi-circle, star, irregular as well as other suitable shapes can be employed to place the jet engines.

In some cases, the engines, e.g., jet engines, employed are used or refurbished. Engines also can be designed and constructed to meet specific requirements of a target, e.g., elevated temperatures, high humidity, high sheer and so forth.

In specific aspects of the invention, multiple engines are assembled in a system, also referred to herein as a “cartridge”. The system can include two, three, four, five, ten, twenty or any other suitable number of jet engines. In preferred aspects of the invention, the system is deployable. A system having a single jet engine also can be used.

For many applications, the systems or parts thereof are built from refractory materials. In other applications, the materials selected are corrosion resistant. Light-weight or sturdy designs are preferred for yet other applications. Systems deployed to control a storm can be fabricated from heavy materials or can be capable of being anchored or weighted down.

The system can be sized based on the application, transportation or deployment means used. Other factors that can be considered include the number of jet engines in the system, the severity or magnitude of target conditions and so forth.

A single target also can be modified by employing several systems.

In some embodiments, rotatable platforms or turrets can be used to individually rotate each turbine in a system. A carousel arrangement for rotating several or all jet engines in a system also can be employed. Equipment for the vertical and/or horizontal movement of the jet engines, individually or together, also can be employed.

In one embodiment, the system includes a fuel storage unit such as a storage tank. The system also can include conduits for directing the fuel to the jet engine(s). Refrigerant and/or cryogenic fluids also can be stored in tanks or other suitable storage vessels. If pure O₂ or O₂ enriched combustion is carried out, or if oxygen is added to the exhaust to provide a life sustaining composition, O₂ storage means or an on-site supply system, e.g., an air separation membrane, is included as well, together with suitable conduits for directing O₂, for instance to the combustion chamber(s) or to be mixed with the exhaust.

Furthermore, the system can include one or more central processing units, e.g., a computer station, and electrical cables and wires for command transmissions to and from the jet engines and/or parts thereof.

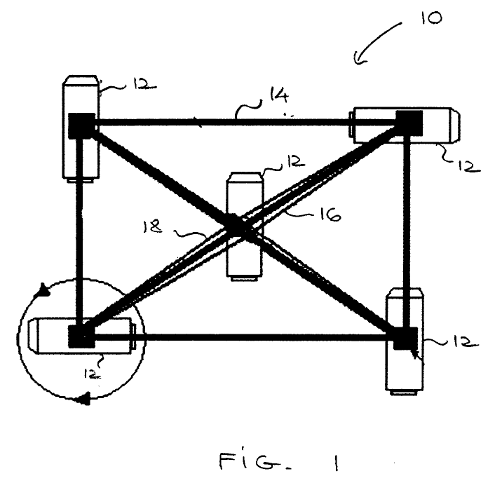

Shown in FIG. 1 is cartridge 10 including five turbine engines 12, essentially as described above, and support 14. Support 14 can be a platform, a wire or cable frame, a scaffold or another arrangement suitable for securing turbine engines 12. In preferred embodiments, turbine engines 12 are capable of individual rotation, indicated by the arrows, so that positioning of exhaust nozzles with respect to the target can be optimized. Rotation can be provided by carousel arrangements, turrets, rotatable plates or disks or by other means. One or more motors can be provided to power the rotation via shafts, bearings, gears and other devices known in the art. If desired, turbine engine 12 also can be repositioned on support 14, for example using tracks, not shown in FIG. 1. Vertical motion with respect to support 14 can be provided by individual lift mechanisms or by other means known in the art. Mechanisms for tilting one or more turbine engines 12 also can be provided.

Cartridge 10 also includes fuel lines 16 and electric cables 18, as further described below.

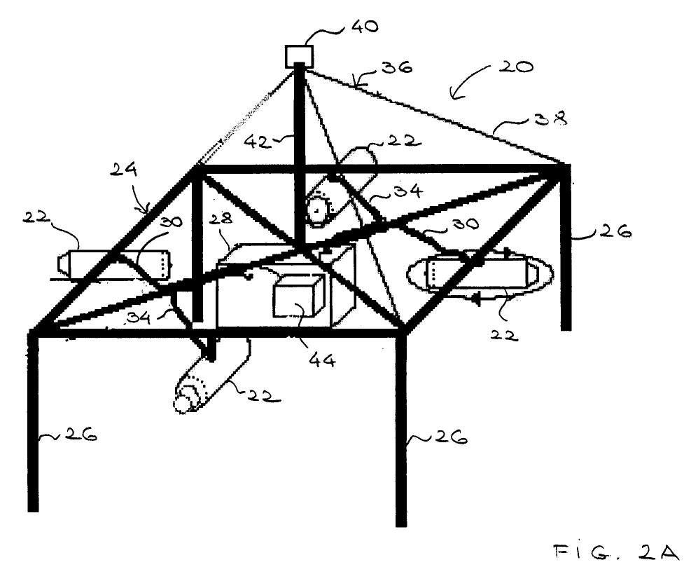

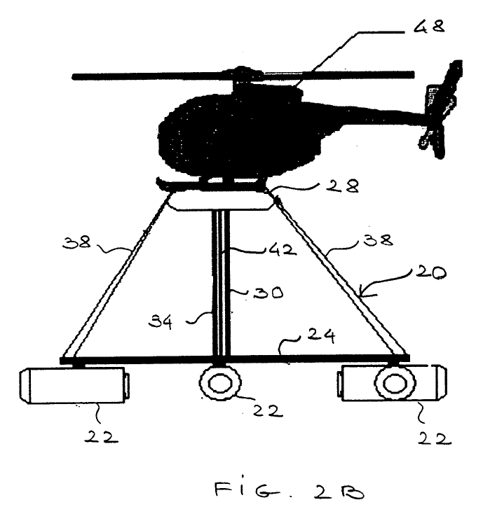

Additional elements can be included in the cartridge. For instance, shown in FIG. 2A is deployable cartridge 20, including turbine engines 22 and support frame 24. Frame legs 26 can be fixed in the open position or can be retractable. In one example, frame legs 26 are provided with pivots or other devices for folding frame legs 26, underneath support frame 24.

Combustion fuel is provided in storage unit 28, e.g., a storage tank. Preferably, storage unit 28 has a sturdy design and is constructed from heat resistant materials. From storage unit 28, fuel is directed to turbine engines 22 through fuel lines 30. Electrical power and remote commands are provided to turbine engines 22 via electrical lines 34. Many different types of fuel can be used, as described above.

Deployable cartridge 20 is delivered and/or removed from the target site by means of assembly 36, which includes cables 38 and attachment 40. In one example, attachment 40 is capable of connecting cartridge 20 to parachute lines. Assembly 36 can also include vertical cable 42 to stabilize and further secure cartridge 20.

For remote or robotic control of deployment and/or recovery operations, deployable cartridge 20 includes central processing unit 44. Central processing unit 44 also can control the operation of turbine engines 22. It includes a power supply, e.g., a battery, automated controls for operating cartridge 20, for rotating turbines 22, controlling jet parameters and so forth. In one example, central processing unit 44 includes a power supply, one or more computer systems, communication, e.g., satellite links, global positioning system (GPS), telemetric devices or other controls for carrying out the operation, deployment and/or retrieval of cartridge 20 by remote or robotic control. In many cases, central processing unit 44 is linked, e.g., by satellite communication, to a command center, which can be stationary or mobile.

Shown in FIG. 2B is a side view of cartridge 20 being deployed or recovered by helicopter 48. In further embodiments, the cartridge can be operated from the air, while the helicopter hovers above the target site.

To maintain cartridge integrity during operation and/or cartridge reusability, a protective shield, for instance a heat resistant shield, can be provided. The protective shield can be fabricated from low flammability or from fire or explosion resistant materials. In other examples, the protective shield is resistant to water or chemical corrosion.

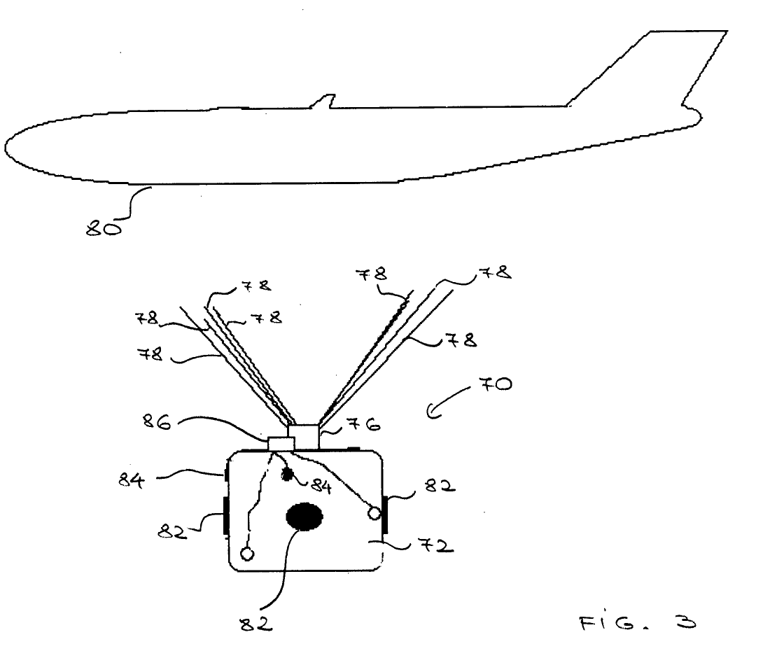

Shown in FIG. 3, is cartridge 70, which includes heat shield 72, cables 74 and attachment 76, capable, for example, of being hooked to parachute lines 78. The parachute not shown in FIG. 3, used to drop cartridge 70 at the target site, can be deployed from aircraft 80. Heat shield 72 is provided with delivery ports 82 for allowing passage of the jet engine exhaust stream(s) towards the target. In one example, delivery ports 82 are provided with gates, not shown in FIG. 3, that are opened for delivery of the exhausts. In the closed position, the gates further protect the jet engines and other elements housed by cartridge 70.

Cartridge 70 can be provided with sensors 84 for detecting conditions, e.g., temperature, chemical composition, etc., at or near the target site. Central processing unit 86 can include one or more computer systems, communication links, GPS and other devices suitable for operating, deploying and/or retrieving cartridge 70.

In further embodiments, a cartridge such as, for instance, cartridge 70, can be modified for dispersing chemicals, for instance diluents, neutralizing agents, water, fire retardants or extinguishers or other substances which can be delivered as a substitute or in addition to the jet engine exhaust.

When desired, a single jet engine or a cartridge including multiple jet engines is transported to or near the target site by helicopter or aircraft as discussed, respectively, with reference to FIG. 2B and FIG. 3. Other suitable means of transport include tanks, boats, ships, barges, trucks, trains, tractor-trailers, railroad cars, rockets, e.g., low speed rockets, and so forth. Cranes also can be employed.

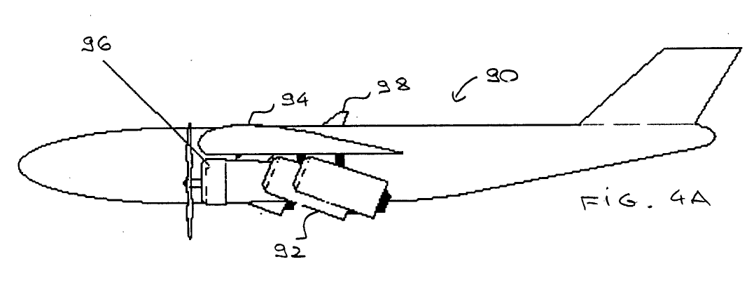

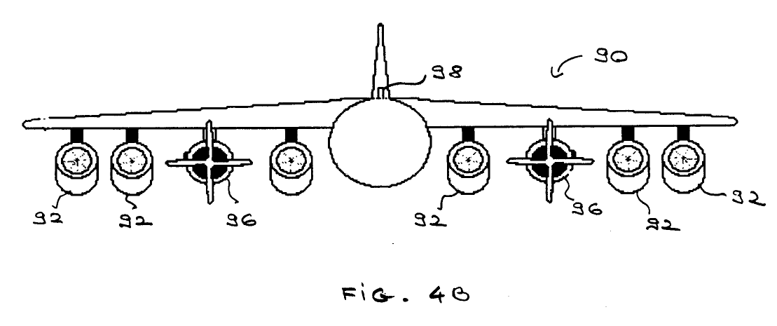

In specific embodiments of the invention, the transport to the target site is by remote control or robotic system. Shown in FIG. 4A and FIG. 4B, for example, is pilotless plane 90 carrying individual jet engines 92 under wings 94. Plane 90 has propellers 96 and is remotely controlled through receiver transmitter 98 and, optionally, via other devices, not shown in FIG. 4A or FIG. 4B.

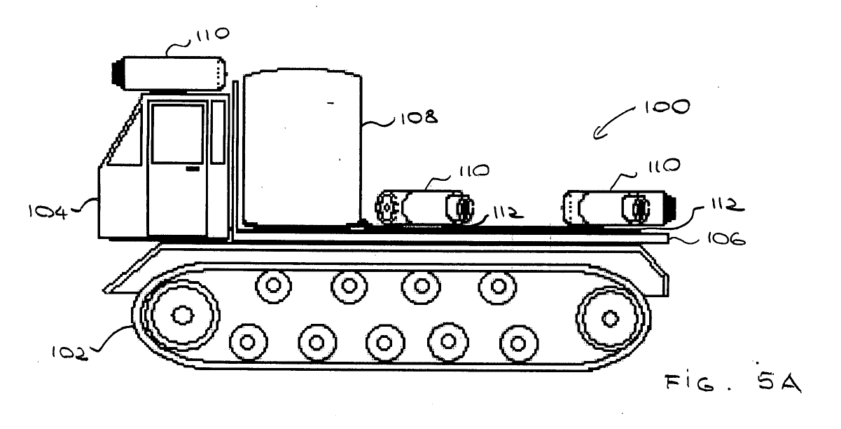

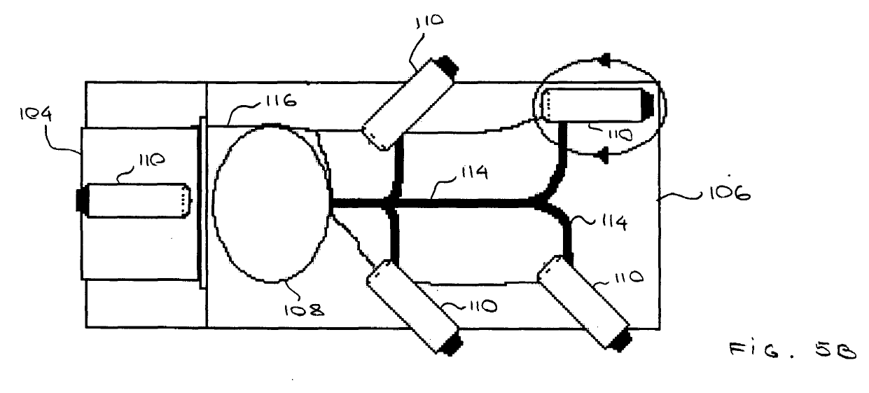

Shown in FIG. 5A is track vehicle 100 including tracks 102, cabin 104 and bed 106. Track vehicle 100 transports jet engine fuel in storage tank 108 and turbine engines 110, optionally on turrets 112. FIG. 5B is a top view of track vehicle 100 transporting storage tank 108 and turbine engines 110, on turrets 112. Also shown in FIG. 5B are fuel lines 114 for supplying fuel to turbine engines 110. Electrical lines 116 provide power to turbines 110 during operation.

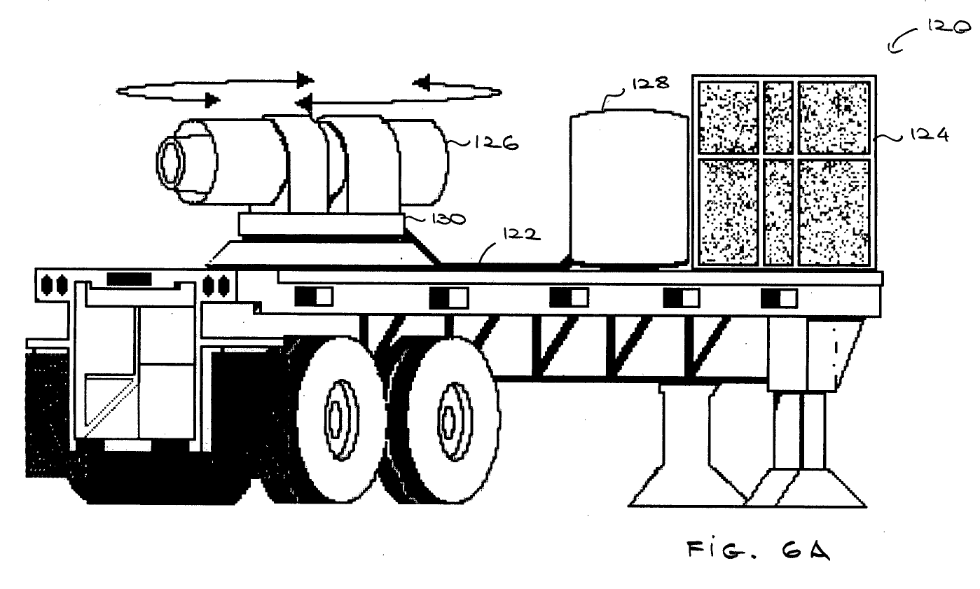

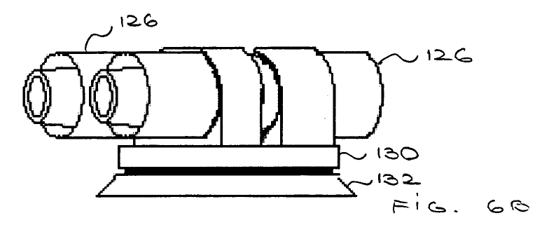

Shown in FIG. 6A is tractor trailer 120 having flatbed 122 and fence 124. Turbine engine 126 receives fuel from storage tank 128 and can be rotated via turret 130. Multiple turbines 126 can be rotated by means of turret 130, mounted on pedestal 132, as illustrated in FIG. 6B.

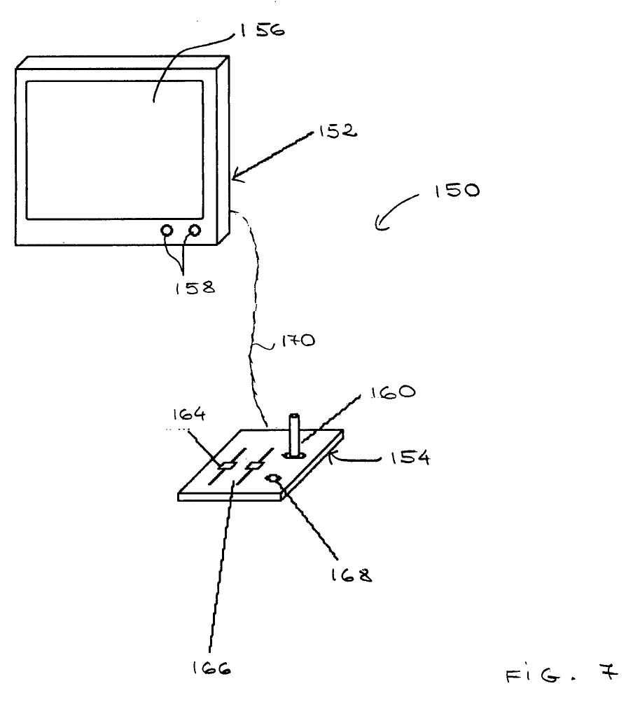

Deployment to the target site and/or operation of the engines at the site can be controlled from a command location, which can be fixed or mobile, using a command system. One example is discussed with reference to FIG. 7. Shown in FIG. 7 is command system 150, which includes console 152 and control panel 154. Console 152 has a telemetric device and display screen 156 for visual tracking of a cartridge, not shown in FIG. 7. Video adjustments 158 are used for controlling image parameters. Control panel 152 includes joy stick 160 for adjusting the tilt and/or rotation of the turbines, RPM control 162 for adjusting the rotations per minute (RPM) of the turbine, nozzle control 164 for constricting or dilating the nozzle and press on button 164 for activating jet disbursement. If desired, cable 170 can be used to connect console 152 to control panel 154. In other examples, cable 170 is replaced by a wireless connection.

Other command controls and arrangements also can be utilized, as known in the art. If a heat shield is employed, controls also can be provided for activating the closing and opening of orifices or of shut-off gates to allow, for instance, ejection of exhaust.

As a result of operating the jet engines as discussed above, one or more target properties are altered. In the case of a target that is a chemical reaction, e.g., a fire or explosion, directing exhaust from a jet into the target generally can slow down the rate of combustion and can change the composition of the reaction mixture. In the case of targets such as crowds, gatherings, flocks or swarms, the population density in the target area is diminished.

Targets that are chemical spills, or masses of harmful chemical substances or agents can be changed with respect to the concentration of the hazardous agent; this concentration generally is reduced.

In some cases the target undergoes a state transition. For example, snow melts, liquids can be vaporized and so forth. Atmospheric systems such as fog, cloud, tornado, or hurricane formations or portions thereof can be dispersed or deflected.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method for displacing a target or parts thereof, the method comprising:
a. deploying an engine to a target site; and
b. directing an exhaust generated by the engine towards the target, thereby displacing it or parts thereof.

2. The method of claim 1, wherein the target is selected from the group consisting of a harmful discharge, flood water, an atmospheric system, a snow accumulation, and a gathering.

3. The method of claim 2, wherein the harmful discharge is a spill, an emission, or a bioagent mass.

4. The method of claim 1, wherein multiple engines are deployed to the target side.

5. The method of claim 1, wherein deploying the engine is by remote control or by a robot.

6. The method of claim 1, wherein the engine is mounted on a turret.

7. The method of claim 1, wherein the exhaust has at least one parameter that is controlled, the parameter being selected from the group consisting of temperature, velocity, chemical composition, flow rate and any combination thereof.

8. The method of claim 7, wherein the parameter is controlled remotely or by robotic means.

9. The method of claim 1, wherein the engine is a jet engine.

10. A method for controlling a fire, the method comprising:
a. deploying a jet engine to a fire site; and
b. directing an exhaust generated by the jet engine to the fire, thereby controlling the fire,
wherein at least one of steps (a) and (b) is controlled remotely or robotically.

11. The method of claim 10, further comprising controlling an exhaust parameter selected from the group consisting of temperature, velocity, chemical composition, delivery rate and any combination thereof.

12. A system for modifying a target, the system comprising:
a. at least one jet engine;
b. a first apparatus for deploying by remote control or robotically the at least one jet engine to a target site;
c. a second apparatus for directing an exhaust generated by the at least one jet engine to the target by remote control or robotically.

13. The system of claim 12, wherein the system includes multiple jet engines.

14. The system of claim 12, further comprising means for controlling an exhaust parameter selected from the group consisting of temperature, velocity, chemical composition, flow rate and any combination thereof.

15. The system of claim 12, wherein the first apparatus includes a transportation unit selected from the group consisting of a truck, a plane and a ship, helicopter, and rocket.

16. The system of claim 12, wherein the second apparatus includes a turret.

17. A system for modifying a target, the system comprising:
a. multiple engines secured to a support;
b. a central processing unit for operating the engines remotely or by robot; and
c. a conduit for supplying fuel from a fuel source to the engines;

18. The system of claim 17, wherein the engines are jet engines.

19. The system of claim 17, wherein the engines are mounted on turrets.

20. The system of claim 17, further including a shield.

21. The system of claim 20, wherein the shield has at least one outlet for directing jet engine exhaust towards the target.

22. A means of transportation including the system of claim 17.

23. The means of transportation of claim 22, further including a central processing unit for deploying said means to a target site.
